(19) United States
(12) Patent Application Publication
(10) Pub. No.: US 2006/0014088 A1
(43) Pub. Date: Jan. 19, 2006

(54) Optically anisotropic body

(75) Inventors: Dirk Kornelis Gerhardus De Boer, Eindhoven (NL); Dirk Jan Broer, Eindhoven (NL); Gerardus Petrus Karman, Eindhoven (NL); Armanda Cindrella Nieuwkerk, Eindhoven (NL); Emiel Peeters, Eindhoven (NL); Blanca Maria Irma Van Der Zande, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklike Philips Electronics N.V., Eindhoven (NL)

(21) Appl. No.: 10/534,765

(22) PCT Filed: Oct. 27, 2003
(86) PCT No.: PCT/IB03/04819

§ 371 Date: May 12, 2005

(30) Foreign Application Priority Data
Nov. 15, 2002 (NL) 1021933

(51) Int. Cl. C09K 19/00

(52) U.S. Cl. 430/20

(57) ABSTRACT

The invention relates to an optically anisotropic body, such as a compensation foil or a micro-lens array, having a desired pattern of optical properties. Said body is obtainable by a method wherein a non-uniform electric and/or magnetic field is applied over a body comprising a polymerizable electro-optical and/or magneto-optical material, such as a LC monomer, thus inducing a desired molecular pattern. The pattern is made permanent by polymerising the electro-optical and/or magnetooptical material.

The present invention relates to an optically anisotropic body, such as a compensation foil, a polariser, or a micro-lens array.

Optically anisotropic films and methods of producing such films are disclosed by D J Broer in “Monodomain Liquid-Crystalline Networks by In-Situ Polymerisation”, chapter 3.3 in Functional Polymers—Synthesis and Applications”, edited by Reza Arshady, American Chemical Society, Washington DC, USA. Generally, a thin film of a polymerizable LC material is first pre-oriented and thereafter polymerized by illumination with UV light. Pre-orientation may be achieved by single surface-induced orientation, such as by applying the polymerizable LC material onto a rubbed alignment layer (e.g. a rubbed polyimide layer), or by using a rubbed alignment layer in combination with application of a uniform electric field.

A disadvantage of the optically anisotropic films and methods of producing such films disclosed by Broer is that only optically anisotropic films of a limited variety and relatively simple patterns of optically anisotropy are available.

An object of the present invention is to expand the range of optically anisotropic bodies, in particular provide optically anisotropic bodies having a relatively complex pattern of optically anisotropy in two or three dimensions, and provide a method for easy manufacturing thereof.

Said object is achieved with an optically anisotropic body being obtainable by a method which comprises providing a body comprising a polymerizable electro-optical and/or magneto-optical material capable of being brought into an optically anisotropic state in response to an electric and/or magnetic field, subjecting the polymerizable electro-optical and/or magneto-optical material to a non-uniform electric and/or magnetic field to establish electric and/or magnetic field lines in accordance with a desired pattern within the electro-optical and/or magneto-optical material, the electric and/or magnetic field lines being of sufficient strength for aligning the material and bringing the material into a desired optically anisotropic state commensurate with the non-uniform electric and/or magnetic field, and polymerising the material in said optically anisotropic state to provide the optically anisotropic body having a well-defined and complex pattern of optically anisotropy.

The desired (molecular) pattern within the electro-optical and/or magneto-optical material induces a desired pattern of optical properties, such as refractive index.

The body is preferably in the form of a sheet, a plate, a film, or a coating. Examples of optically anisotropic bodies obtainable are compensation foils, polarisers, and micro-lens arrays.

The polymerizable electro-optical and/or magneto-optical material preferably comprises at least one polymerizable liquid crystal (LC) monomer, such as ((6-(acryloyloxy)-hexyl)oxy)-4-((4-((6-(acryloyloxy)hexyl)-oxy)-benzoyl)-oxy)benzoyl)oxy)benzene.

A mixture of different LC monomers may be used as well as a mixture of one or more LC monomers with a non-reactive liquid crystal.

Furthermore, the LC monomer(s) may be mixed with a second non-LC monomer or used alone.

The body comprising said polymerizable material is preferably provided on an alignment layer, such as a rubbed polyimide layer, which results in a surface-induced orientation.

A non-uniform electric and/or magnetic field is preferably applied by use of a plurality of spaced electrodes and/or magnetic poles, or at least one structured electrode pair and/or magnetic pole pair.

The plurality of spaced electrodes and/or magnetic poles may also be structured.

Preferably, the plurality of spaced electrodes and/or magnetic poles are arranged at one side of the body.

Preferably, one or more of the electrode(s) and/or magnetic pole(s) that is/are used to apply said non-uniform electric and/or magnetic field is/are part of the body.

More preferably, a plurality of spaced electrodes and/or magnetic poles are arranged at one side of the body.

The optically anisotropic body may be a polariser, a compensation foil, a micro-lens array, e.g. for use as a collimator in a LCD, or any other optical component for use in an optical device, such as a display device, e.g. a LCD.

Other features and advantages of the present invention will become apparent from the embodiments described hereinafter.

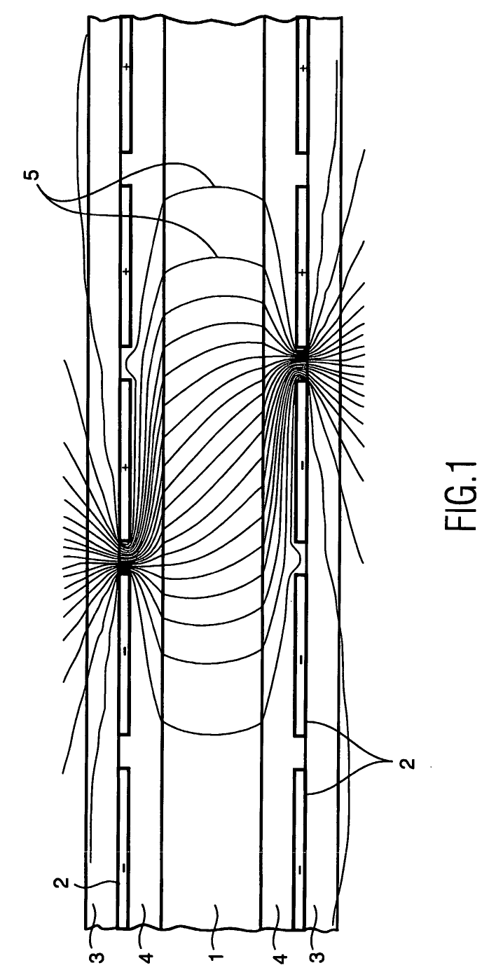

FIG. 1 schematically shows a first electrode structure applicable for obtaining an optically anisotropic body according to an embodiment of the invention.

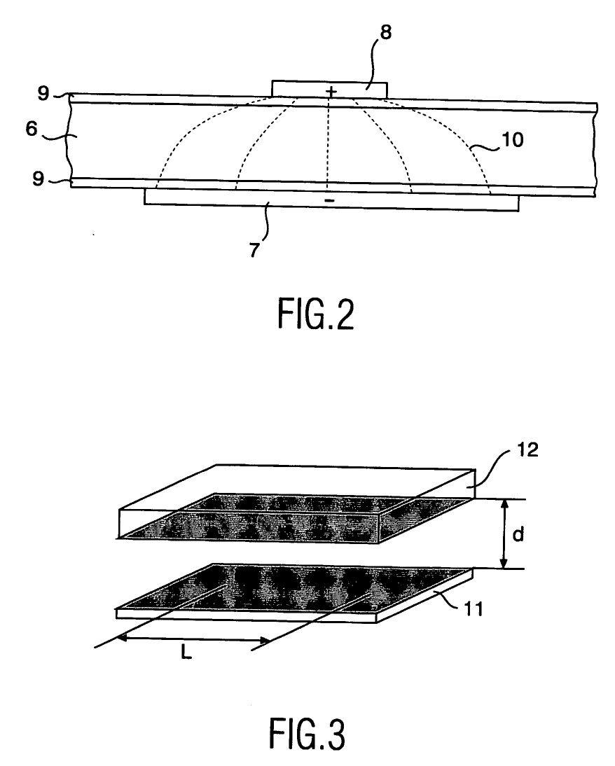

FIG. 2 schematically shows a second electrode structure applicable for obtaining an optically anisotropic body according to an embodiment of the invention.

FIG. 3 schematically shows a third electrode structure applicable for obtaining an optically anisotropic body according to an embodiment of the invention.

First of all, it shall be noted that in all embodiments disclosed hereinafter, magnetic poles may be used instead of the electrodes, or magnetic poles may be used in combination with the electrodes.

FIG. 1 shows a set-up (not according to scale) which may be used in for obtaining an optically anisotropic body according to an embodiment of the invention to produce, for instance, a patterned compensation foil with tilted directors (described below).

A sheet-formed body I of a photo-polymerizable LC material is placed between glass plates 3 on which a plurality of spaced transparent electrodes 2 (e.g. ITO (indium tin oxide) electrodes) are arranged as shown in FIG. 1. A thin coating of a dielectricum 4 is optionally placed between the body 1 and the electrodes 2.

As used herein, the term “a plurality of electrodes” refers to a plurality of spaced anodes and cathodes, respectively. The anodes and cathodes, respectively, may be spaced by, for instance, non-conducting material.

The body 1 comprises surfaces which faces the electrodes 2. Anodes (−) and cathodes (+) are arranged at both sides of the body 1. The distances between the electrodes 2 arranged at the same side of the body 1 is equal to or smaller than the gap between electrodes 2 arranged at opposite sides of the body 1.

These electrodes 2 provide a non-uniform spatially modulated electric field comprising non-parallel, curved equipotential field lines 5 that are non-perpendicular with respect to a plane parallel to the surfaces of the body I facing the electrodes. If the field is of sufficient strength, liquid crystal molecules in the bulk of the material will be directed perpendicular to these equipotential lines 5. As known in the art, equipotential field lines are perpendicular to the field lines that show the direction of the field (referred to as field lines). Thus, the LC directors will be directed along these (non-equipotential) field lines.

As used herein the term “non-uniform electric and/or magnetic field” means a spatially modulated field comprising non-parallel and/or non-straight (curved) field lines. A non-uniform field may however also comprise some field lines that are parallel to each other, and/or some straight field lines.

When brought into a liquid crystal state, the long-range orientation order of the LC molecules renders the material in an optically anisotropic state. Associated with this orientation order is a director vector (also referred to as director) which indicates the direction of molecular orientation within the material, the collection of such directors forming a vector field. When subjecting the polymerizable material to an electric (and/or magnetic) field, the material is brought into the desired mesomorphous state having the desired director vector field.

The optical properties of a LC material in the mesomorphic state, such as its refractive index, are determined by the type and degree of order in that state.

Thus, the applied non-uniform spatially modulated electric field induces a desired molecular pattern, in accordance with the applied field as disclosed above, comprising LC molecules having tilted directors. The well-defined molecular pattern will give rise to desired optical properties that make the foil suitable for use as a compensation foil.

As used herein the term “tilted directors” refers to director vectors which is neither parallel nor perpendicular (90°) to a plane parallel to a surface of the body facing an electrode (and/or magnetic pole).

When the desired pattern has been obtained, the material is polymerized while maintaining the electric field and thus the induced pattern. Polymerisation is achieved by irradiation with UV light. The UV light affects a photoinitiator in the LC material which under the influence of UV light induces free-radical polymerisation of the LC material. During polymerisation the induced orientations of the LC molecules are frozen.

After completed polymerisation, the voltage is removed and a patterned compensation foil with permanent optical properties is obtained. The compensation foil having said desired molecular pattern, in correspondence to the applied field, comprises liquid crystals displaying tilted directors.

As known in the art, a compensation foil, also referred to as retardation foil or retarder, may be placed between a LC layer and an outer polariser in order to provide a LC display having a reduced angle dependency. A compensation foil induces an additional change in the polarisation state (next to that induced by the LC layer) which counteracts the effect of the LC layer. Thus, the foil alters the polarisation state of obliquely passing light so that it experiences the same total birefringence as normally passing light. The compensation foil is a static layer of which the birefringence and isotropy is opposite to that of the LC layer. By using a compensation foil, the contrast under oblique viewing angles may be improved.

Optical bodies, in particular compensation foils, having a wide range of complex and well-defined molecular patterns is obtainable. For each specific use, the pattern is, as known in the art, adapted to give desired optical properties associated with said use.

The compensation foil is preferably patterned, i.e. it may comprise multi-domains. The pattern consists of different areas having different directions of optical axes, either in the plane of the layer (different azimuthal angles) or outside this plane (different tilt angles), each area having a birefringence counteracting that of the adjacent LC layer.

FIG. 2 shows a set-up (not according to scale) which may be used for obtaining an optically anisotropic body according to an embodiment of the invention to produce a micro-lens or a micro-lens array.

A sheet-formed body 6 of a photo-polymerizable LC material is placed between a plurality of structured transparent electrodes 7 and 8(e.g. ITO electrodes), each electrode pair comprising one large bottom 7 and one small top electrode 8 (only one of several electrode pairs is shown in FIG. 2). The anodes (−) are arranged at one side of the body and the cathodes (+) are arranged at the opposite side. Plates of a dielectricum 8, such as glass, are placed between the body 6 and the electrodes 7 and 8. Alternatively, the electrodes may be applied on the side of the glass plates facing the sheet-formed body.

As used herein, the term “structured electrodes” refers to an electrode pair having differently sized electrode surfaces. Examples of structured electrodes are (i) an electrode pair having slits on one electrode plate and/or protrusions on the other, (ii) an electrode pair comprising one large and one small electrode, and (iii) an electrode pair comprising one electrode having a cavity and one without cavity.

The body 6 shown in FIG. 2 comprises surfaces facing the electrodes 7 and 8. The electrodes 7 and 8 provide a non-uniform spatially modulated electric field comprising non-parallel, curved electrical field lines 10 that are non-perpendicular to said surfaces of the body 6. The liquid crystals will be directed along these electrical field lines 10 giving rise to a refractive index profile following the field lines 10 and thus a foil having lens action. The curvature of the liquid crystal alignment, which depends on the voltage applied, guides incoming light waves to convert to a focal point. Thus, the focal length may be tuned by the voltage applied.

When the desired pattern has been obtained, the material is polymerized, as described above, while maintaining the electric field and thus the induced pattern.

A micro-lens array with permanent optical properties in the form of a foil is obtained. The micro-lens array comprises liquid crystals displaying tilted directors.

A micro-lens array may, for instance, be used as a collimator in a liquid crystal display (LCD) for collimation of light. However, as known in the art micro-lenses are used in a variety of applications in machine vision and photonics.

An alternative electrode set-up (not according to scale) for production of a micro-lens or a micro-lens array according to the invention is shown in FIG. 3. The structured transparent electrode pair (e.g. ITO electrodes) shown in FIG. 3 comprises one electrode 11 having a cavity and one electrode 12 without cavity. For the production of a micro-lens array, several electrode pairs as shown in FIG. 3 may be utilized.

Still another electrode set-up which may be used for obtaining an optically anisotropic body according to an embodiment of the invention comprises a plurality of spaced electrodes (both anodes and cathodes) arranged at only one side of the body. Such electrodes are usually used in in-plane switching LCDs. These electrodes may also be structured.

In all of the above described embodiments, the body comprising said polymerizable material is preferably provided on an alignment layer, such as a rubbed polyimide layer, which results in a surface-induced molecular orientation.

The polymerizable electro-optical and/or magneto-optical material preferably comprises at least one polymerizable liquid crystal (LC) monomer, such as ((6-(acryloyloxy)-hexyl)oxy)-4-((4-((6-(acryloyloxy)hexyl)-oxy)benzoyl)-oxy)benzoyl)oxy)benzene. This monomer is advantageous since it has a positive dielectric anisotropy, which means that it orient itself parallel to the electric/magnetic field lines. Examples of other suitable monomers are given by D J Broer in “Monodomain Liquid-Crystalline Networks by In-Situ Polymerisation”, chapter 3.3 in Functional Polymers—Synthesis and Applications”, edited by Reza Arshady, American Chemical Society, Washington DC, USA, which monomers are hereby incorporated by reference.

Reactive liquid crystals comprise a stiff central core, such as C₆H₅—C₆H₅, C₆H₅—C═C—C₆H₅, C₆H₅—COO—C₆H ₁₁, and C₆H₅—COO—C₆H₅—OOC—C₆H₅, coupled at each side to flexible spacer groups, such as —(CH₂)ₓ— and —O—(CH₂)ₓ—, wherein x is 0-12. The spacer groups are coupled to polymerizable end groups, such as (meth)acrylates, vinylethers, epoxides, and thiolenes.

An exemplary group of suitable monomers is bis[(4-ω-acryloyloxy)alkyloxy]-benzoates. However, this group of monomers has a slightly negative anisotropy, which requires the addition of positive dielectric anisotropic cyanobiphenyl.

A mixture of different LC monomers may be used as well as a mixture of one or more LC monomers with a non-reactive liquid crystal.

Furthermore, the LC monomer(s) may be mixed with a second non-LC monomer, which polymerize by the same mechanism as the LC monomer(s), or used alone.

As known to skilled persons in the art, a small quantity of a free-radical scavenger or inhibitor may be added to the electro-optical and/or magneto-optical material to stabilize the monomer(s) in the non-polymerized state.

As known to skilled persons in the art, additives, such as a thermal initiator, a photoinitiator, a chain transfer agent, and the like, may be added to the electro-optical and/or magneto-optical material to enhance the polymerisation process.

Preferably, the electro-optical and/or magneto-optical material comprises a photoinitiator, such as α,α-dimethoxydeoxybenzoin, which under the influence of actinic radiation, in particular UV light, induces free-radical polymerisation of the electro-optical and/or magneto-optical material.

As known to skilled persons in the art, solvents and surfactants may be utilised to enhance thin film formation.

Furthermore, as known to skilled persons in the art, stabilizers may be added to enhance the stability of the electro-optical and/or magneto-optical material at high temperatures or under severe light exposure.

Thus, the polymerizable electro-optical and/or magneto-optical material is preferably a photo-polymerizable liquid crystal (LC) monomer, such as ((6-(acryloyloxy)-hexyl)oxy)-4-((4-((6-(acryloyloxy)hexyl)-oxy)benzoyl)-oxy)benzoyl)oxy)benzene, mixed with a photoinitiator, such as a,a-dimethoxydeoxybenzoin (commercially available under the trade name Irgacure 651 from Ciba Geigy, Switzerland).

The invention also makes an optically anisotropic body having domains of different optical properties obtainable by controlling the direction of director vectors, the relative size of the domains and/or the optical retardation (depends on thickness and birefringence) of the domains.

The optical properties of said optically anisotropic body may differ with regard to light refraction (refractive index), light diffraction or influence on light polarisation state.

Besides compensation foils and micro-lens arrays as disclosed above, polarisers or other optical components, such as lenses and prisms, are obtainable according to the invention.

The optical body may advantageously comprise at least one electrode (and/or magnetic pole) used during production of the optical body. Said at least one electrode may perform a further function in the optical body or, if transparent, merely remain as a non-functional remnant.

Preferably, the optically anisotropic body comprises a plurality of spaced electrodes arranged at one side of the body.

The invention will now be further illustrated by means of the following non-limiting examples.

### EXAMPLES

A reactive liquid crystal mixture was made by blending 5 g of 1,4-phenylene-bis-[4-(6-(acryloyloxy)hexyl-oxy)]benzoate, 1 g of E7 (commercially available from Merck Ltd, United Kingdom), which is a mixture of cyanobiphenyls (4-5-pentyl-4′-cyanobiphenyl, 4-7-heptyl-4′-cyanobiphenyl, and 4-8-octyloxy-4′-cyanobiphenyl) and a cyanoterphenyl (4-5-pentyl-4″-cyano-p-terphenyl), and 0.06 g of Irgacure 651 (α,α-dimethoxydeoxybenzoin) (commercially available from Ciba Geigy, Switzerland).

1,4-phenylene-bis-[4-(6-(acryloyloxy)hexyl-oxy)]-benzoate is a LC monomer. E7 has a positive dielectric anisotropy which helps the monomer to align along the electrical field lines.

Irgacure 651 is a photoinitiator.

This mixture was processed at 100° C. to a thin film between two glass plates provided with electrodes and rubbed polyimide. The rubbed polyimide establishes a planar alignment of the LC monomers in the rubbing direction.

The desired orientation of the LC monomers was obtained by applying a voltage of 12 V over the electrode structure.

The obtained orientation was permanently fixed by UV light exposure of the film. The UV light source was a PL10 fluorescent lamp from Philips emitting at a wavelength of 350 nm and having an intensity of 5 mW/cm².

### Example 1

The set-up shown in FIG. 1 is used in the above described experiment. The cell gap between the electrodes arranged at opposite sides of the film is 5 μm, and the electrode distance between electrodes arranged at the same side of the film is 5 μm. The width of each electrode is 50 μm. A thin layer of rubbed polymide is applied on top of the dielectric coating. The total thickness of the rubbed polyimide layer and the dielectric coating is 1 μm.

A patterned compensation foil with tilted directors as disclosed above is obtained.

### Example 2

The set-up shown in FIG. 3 is used in the above described experiment. In the electrode structure, L is 100 μm, d is 50 μm, and the distance between the neighbouring electrode cavities is 100 μm.

A micro-lens array as disclosed above is obtained.

### Example 3

An electrode structure comprising a plurality of spaced electrodes (both anodes and cathodes) arranged at only one side of the film is used in the above described experiment. The electrode structure has a cell gap of 4 μm, an electrode width of 6 μm, and an electrode distance of 6 μm. The electrodes are applied on top of one of the glass plates.

A patterned compensation foil with tilted directors and incorporated electrodes is obtained.

The above disclosure and the Examples show that optically anisotropic bodies of a wide range of two- and three-dimensional patterns are obtainable according to the invention.

While the invention has been described in detail and with reference to specific embodiments thereof, it will be apparent for one skilled in the art that various changes and modifications can be made therein without departing from the spirit and scope thereof.

1. An optically anisotropic body characterized in being obtainable by providing a body comprising a polymerizable electro-optical and/or magneto-optical material capable of being brought into an optically anisotropic state in response to an electric and/or magnetic field,
subjecting the polymerizable electro-optical and/or magneto-optical material to a non-uniform electric and/or magnetic field to establish electric and/or magnetic field lines in accordance with a desired pattern within the electro-optical and/or magneto-optical material, the electric and/or magnetic field lines being of sufficient strength for aligning the material and bringing the material into a desired optically anisotropic state commensurate with the non-uniform electric and/or magnetic field, and
polymerising the material in said optically anisotropic state to provide the optically anisotropic body.

2. An optically anisotropic body according to claim 1, wherein the electro-optical and/or magneto-optical material is a liquid crystal (LC) monomer.

3. An optically anisotropic body according to claim 1, wherein the body comprising said polymerizable material is provided on an alignment layer.

4. An optically anisotropic body according to claim 1, wherein said non-uniform electric and/or magnetic field is applied by use of a plurality of spaced electrodes and/or magnetic poles.

5. An optically anisotropic body according to claim 1, wherein said non-uniform electric and/or magnetic field is applied by use of at least one structured electrode and/or magnetic pole pair.

6. An optically anisotropic body according to claim 4, wherein said non-uniform electric and/or magnetic field is applied by use of a plurality of spaced electrodes and/or magnetic poles arranged at one side of the body.

7. An optically anisotropic body according to claim 1, wherein one or more electrode(s) and/or magnetic pole(s) is/are part of the body.

8. An optically anisoptropic body according to claim 7, which comprises a plurality of spaced electrodes and/or magnetic poles arranged at one side of the body.

9. An optically anisotropic body according to my claim 1, which is selected from the group consisting of a polariser, a compensation foil, and a micro-lens array.
